(19) United States
(12) Patent Application Publication
(10) Pub. No.: US 2024/0415368 A1
(43) Pub. Date: Dec. 19, 2024

(54) END CAP AS ENGAGEMENT AND DISENGAGEMENT MECHANISM FOR A SLIDE ASSEMBLY

(71) Applicant: Haier US Appliance Solutions, Inc., Wilmington, DE (US)

(72) Inventor: Abhisek Agrawal, Louisville, KY (US)

(21) Appl. No.: 18/335,674

(22) Filed: Jun. 15, 2023

(51) Int. Cl. A47L 15/50; F16C 29/04

(52) U.S. Cl. CPC A47L 15/507; F16C 29/043; F16C 2314/00

(57) ABSTRACT

A dishwasher appliance may include a slide assembly that may be mounted within the dishwasher appliance. The slide assembly may include an inner member including an engagement tab. The slide assembly may also include a ball bearing slide that is transitionable between an engaged and a disengaged position relative to the inner member. Further, the slide assembly may include an end cap that may be attached and positioned, at least partially, within the ball bearing slide.

### FIELD

The present subject matter relates generally to a slide assembly, and more particularly to an end cap of a slide assembly that functions as an engagement and disengagement mechanism for the slide assembly.

### BACKGROUND

Dishwasher appliances generally include a tub that defines a wash chamber. Often dishwasher appliances may include slide assemblies for supporting one or more dish racks within the wash chamber and enabling movement of the dish racks in and out of the wash chamber. In conventional designs, a separate engagement mechanism, such as a lever, may be employed between the slide rails of the slide assembly. Such designs, however, generally require numerous single use and specialized parts that may be attached to the slide rails. Furthermore, such designs and parts may limit the variety of slide rail configurations that may be used and may also increase part procurement times.

Accordingly, a dishwasher appliance that utilizes an engagement mechanism that is formed integrally into an end cap of the slide assembly would be useful. More specifically, an end cap that reduces part count of the slide assembly and increases usable space within the slide assembly would be beneficial.

### BRIEF DESCRIPTION

Aspects and advantages of the invention will be set forth in part in the following description, or may be apparent from the description, or may be learned through practice of the invention.

In one exemplary embodiment, a dishwasher appliance defining a vertical direction, a lateral direction, and a transverse direction is provided. The dishwasher appliance may include a tub that defines a wash chamber. The tub may include a tub side wall. The dishwasher appliance may also include a slide assembly that is mounted within the dishwasher appliance. The slide assembly may include an inner member that includes an engagement tab. The slide assembly may also include a ball bearing slide that may be transitionable between an engaged and a disengaged position relative to the inner member. Further, the slide assembly may include an end cap that may be attached to the ball bearing slide. The end cap may include an end cap body and a lever body. The lever body may be positioned freely within the ball bearing slide.

In another exemplary embodiment, a dishwasher appliance is provided. The dishwasher appliance may include a slide assembly that may be mounted within the dishwasher appliance. The slide assembly may include an inner member that includes an engagement tab. The slide assembly may also include a ball bearing slide that may be transitionable between an engaged position and a disengaged position relative to the inner member. Further, the end cap may be attached to and positioned, at least partially, within the ball bearing slide.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to one or more exemplary embodiments of the present subject matter.

FIG. 2 provides a side, partially cut away view of the exemplary dishwasher appliance of FIG. 1.

FIG. 3 provides a perspective view of a slide assembly mounted within a dishwasher appliance, such as the dishwasher appliance of FIGS. 1 and 2, according to one or more exemplary embodiments of the present subject matter.

FIG. 4 provides a perspective view of an inner member of a slide assembly according to one or more exemplary embodiments of the present subject matter.

FIG. 5 provides a perspective view of an end cap of a slide assembly according to one or more exemplary embodiments of the present subject matter.

FIG. 6 provides a perspective view of an end cap of a slide assembly according to one or more exemplary embodiments of the present subject matter.

FIG. 7 provides a close-up perspective view of a portion of a slide assembly according to one or more exemplary embodiments of the present subject matter.

FIG. 8 provides a close-up cross sectional view of a slide assembly according to one or more exemplary embodiments of the present subject matter.

FIG. 9 provides a close-up cross sectional view of a slide assembly according to one or more exemplary embodiments of the present subject matter.

FIG. 10 provides a close-up cross sectional view of a slide assembly according to one or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise, or counterclockwise, with the vertical direction V.

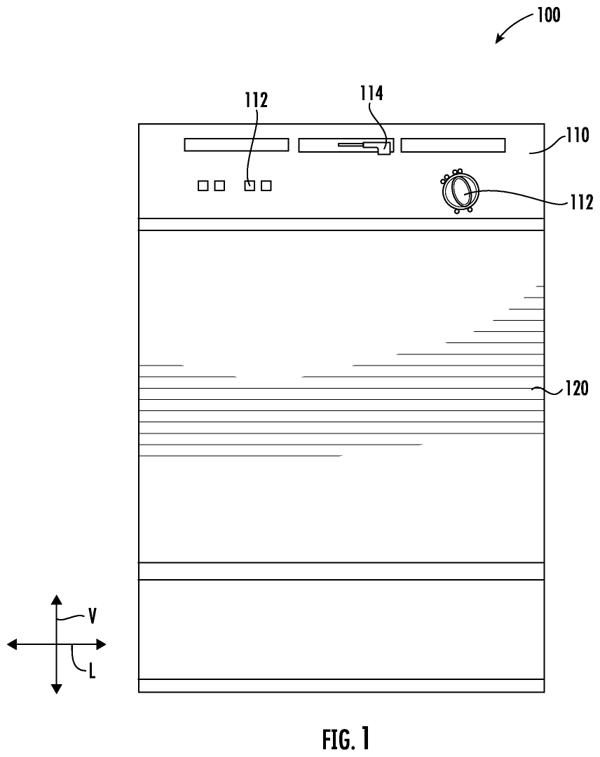

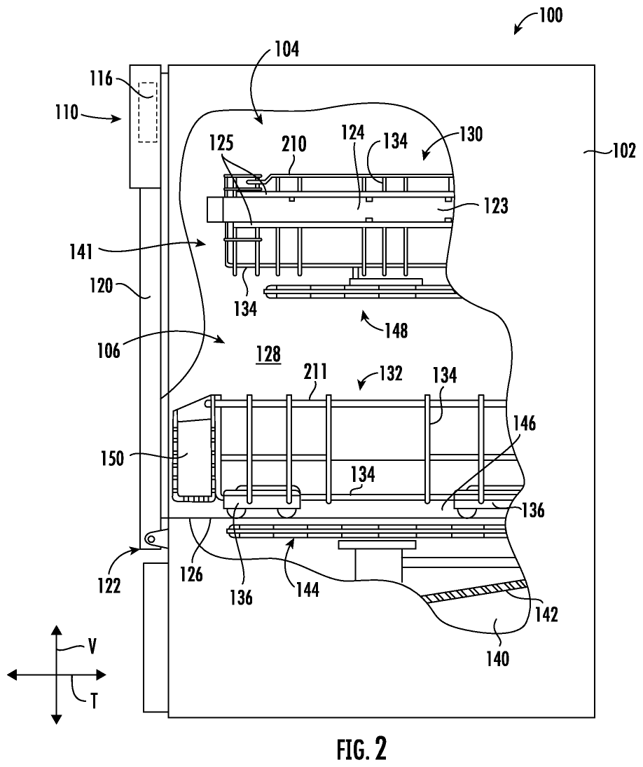

Referring now to FIGS. 1 and 2, a dishwasher appliance 100 according to one or more exemplary embodiments of the present subject matter is provided. FIG. 1 provides a front elevation view of the dishwasher appliance 100 and FIG. 2 provides a side, partially cut away view of the dishwasher appliance 100 of FIG. 1. As depicted, the dishwasher appliance 100 may define a vertical direction V, a lateral direction L, and a transverse direction T. The vertical direction V, the lateral direction L, and the transverse direction T each being mutually perpendicular with every other, such that an orthogonal direction system is generally defined.

The dishwasher appliance 100 may include a cabinet 102 having a tub 104 therein that defines a wash chamber 106. The tub 104 may a back wall 111 positioned at a transverse depth, e.g., approximately along or approximately parallel to the transverse direction. In addition, the tub 104 may include a front opening and a door 120 that may be hinged at a bottom 122 for movement between a normally closed vertical position, e.g., FIGS. 1 and 2, wherein the wash chamber 106 is sealed shut for washing operation, and a horizontal open position (not depicted), wherein the loading and unloading of articles from the dishwasher appliance 100 may occur. In some instances, such as depicted in FIG. 1, the dishwasher appliance 100 may include a latch 114 that may be used to lock and unlock the door 120 such that access to the wash chamber 106 may be permitted or restricted.

In addition, the dishwasher appliance 100 may include one or more rack assemblies, such as an upper rack assembly 130 and a lower rack assembly 132, that may be used to load articles in the dishwasher appliance 100. The upper rack assembly 130 may be mounted within the dishwasher appliance 100 in an upper region 141 of the wash chamber 106, e.g., above the lower rack assembly 132 with respect to the vertical direction V. The rack assemblies 130, 132 may each be adapted for movement substantially along the transverse direction T between an extended loading position in which the respective rack assembly 130, 132 is positioned substantially outside the wash chamber 106 and a retracted position in which the respective rack assembly 130, 132 may be located entirely within the wash chamber 106. Particularly, the movement of the upper rack assembly 130 between the extended loading position and the retracted position may generally be facilitated by a pair of slide assemblies 125 that may be positioned at opposing lateral sides of the upper rack assembly 130. Additionally, the movement of the lower rack assembly 132 may be facilitated by a pair of roller assemblies 136 that may be positioned at opposing lateral sides of the lower rack assembly 132.

The rack assemblies 130, 132 may each include a dishrack for holding articles therein, e.g., for the cleaning of the articles. For instance, the upper rack assembly 130 may include an adjustable dishrack 210 and the lower rack assembly 132 may include a lower dishrack 211. The dishracks 210, 211 may each include a plurality of elongated member or rails 134 that may each be extended in the lateral direction L, the transverse direction T, and the vertical direction V. The plurality of rails 134 may be wires, rods, or any other suitable member, which may be fabricated into a lattice structure to form the shape of the respective dishrack 210, 211.

The pair of slide assemblies 125 may be any suitable pair of slide assemblies, for example, as depicted and described herein, the pair of slide assemblies 125 may be a pair of ball bearing slide assemblies that each include an inner member 250 that may be mounted to, fixed to, or attached to, a tub side wall 128 of the tub 104 and ball bearing slides 280 that may be attached to or mounted to a respective lateral side of the adjustable dishrack 210. Further, the ball bearing slides 280 may be slidably mounted onto the respective inner member 250 such that the ball bearing slides 280 may slide along the respective inner member 250, e.g., to move the upper rack assembly 130 between the extended loading position and the retracted position. As such the slide assembly 125 may be moved substantially along the transverse direction T, between the extended loading position and the retracted position.

In addition, lower guides 126 may be positioned in opposing manner of the sides of wash chamber 106 and provide a ridge or shelf for roller assemblies 136 so as to support and provide movement for the lower rack assembly 132. Optionally, a silverware basket 150 may be removably attached to the lower rack assembly 132 for placement of silverware, small utensils, and the like, which are too small to be accommodated by the upper rack assembly 130 and the lower rack assembly 132.

Further, the dishwasher appliance 100 may include a lower spray assembly 144 that may be rotatably mounted within a lower region 146 of the wash chamber 106 and above a tub sump portion 142 so as to rotate in relatively close proximity to the lower rack assembly 132, e.g., in closer proximity to the lower rack assembly 132 than to the upper rack assembly 130. In addition, the dishwasher appliance 100 may include a mid-level spray assembly 148 that may be located in the upper region 141 of the wash chamber 106 and may attached to, or located in close proximity to, the upper rack assembly 130, e.g., the mid-level spray assembly 148 may be in “close proximity” to the upper rack assembly 130 in that the mid-level spray assembly 148 is closer to the upper rack assembly 130 than to the lower rack assembly 132. In some embodiments an upper spray assembly (not shown) may additionally be located above the upper rack assembly 130.

The lower spray assembly 144, the mid-level spray assembly 148, and the upper spray assembly may be fed by a fluid circulation assembly that may be configured for circulating water and wash fluid in the tub 104. Portions of the fluid circulation assembly may be located in a machinery compartment 140 located below the tub sump portion 142 of the tub 104, as generally recognized in the art. Each spray assembly, e.g., lower spray assembly 144, mid-level spray assembly 148, and upper spray assembly, may include an arrangement of discharge ports or orifices for directing washing liquid onto dishes or other articles located in the upper rack assembly 130 and the lower rack assembly 132, respectively. The arrangement of the discharge ports in at least the lower spray assembly 144 may provide a rotational force by virtue of the washing fluid flowing through the discharge ports. The resultant rotation of the lower spray assembly 144 may provide coverage of dishes and other articles with a washing spray.

The dishwasher appliance 100 may further be equipped with a controller 116 to regulate operation of dishwasher appliance 100. The controller 116 may include a memory, e.g., non-transitive memory, and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 116 may be positioned in a variety of locations throughout dishwasher appliance 100. For example, as depicted in FIGS. 1 and 2, the controller 116 may be located within a control panel area 110 of the door 120. In such an embodiment, input/output (“I/O”) signals may be routed between the control system and various operational components of dishwasher appliance 100 along wiring harnesses that may be routed through bottom 122 of door 120. In certain embodiments, the control panel area 110 may include input components 112 through which a user may select various operational features and modes and monitor progress of the dishwasher appliance 100. For instance, in some embodiments, input components 112 may be a variety of electrical, mechanical, or electro-mechanical input devices including rotary dials, e.g., FIG. 1, push buttons, e.g., FIG. 1, or touch pads, etc. In some embodiments, the control panel area 110 may include a display component, such as a digital or analog display device designed to provide operational feedback to a user. The input components 112 may be in communication with controller 116 via one or more signal lines or shared communication busses.

It should be appreciated that the present subject matter is not limited to any particular style, model, or configuration of dishwasher appliance. Thus, the exemplary embodiment depicted in FIGS. 1 and 2 are for illustrative purposes only. For example, different locations may be provided for the input components 112, different configurations may be provided for the upper rack assembly 130 and the lower rack assembly 132, and other differences may be applied as well.

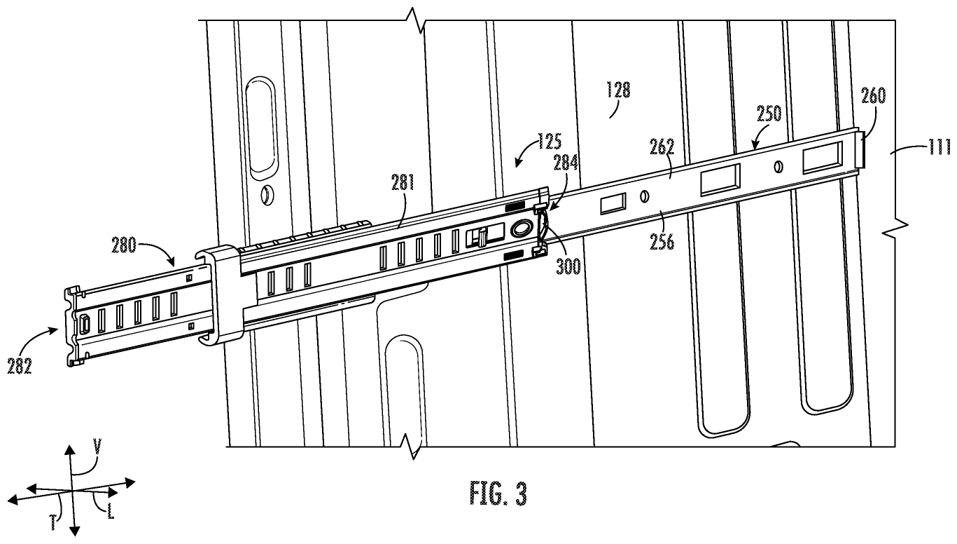

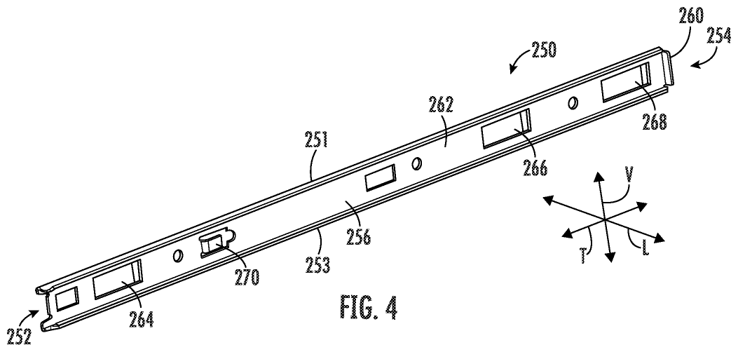

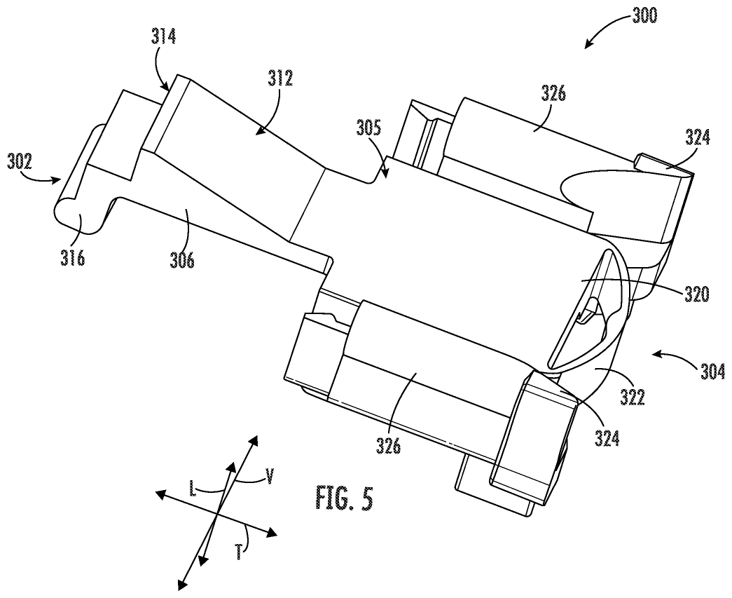

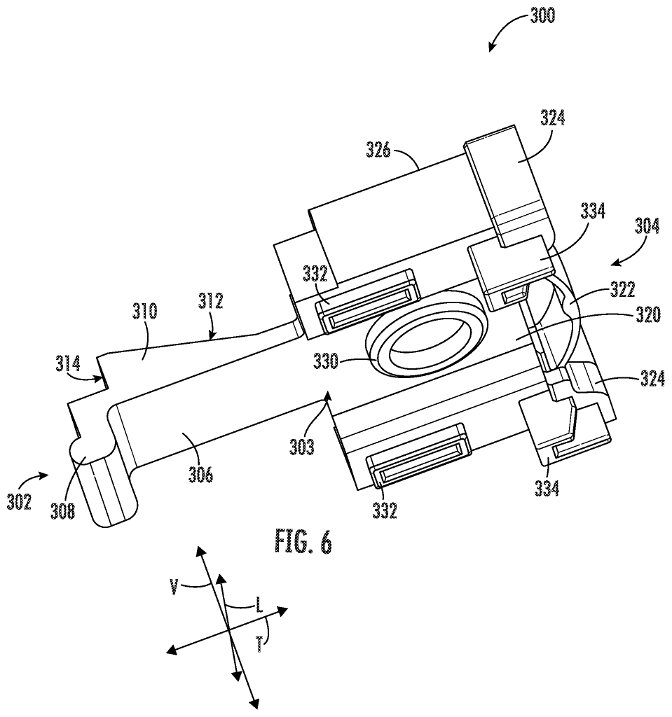

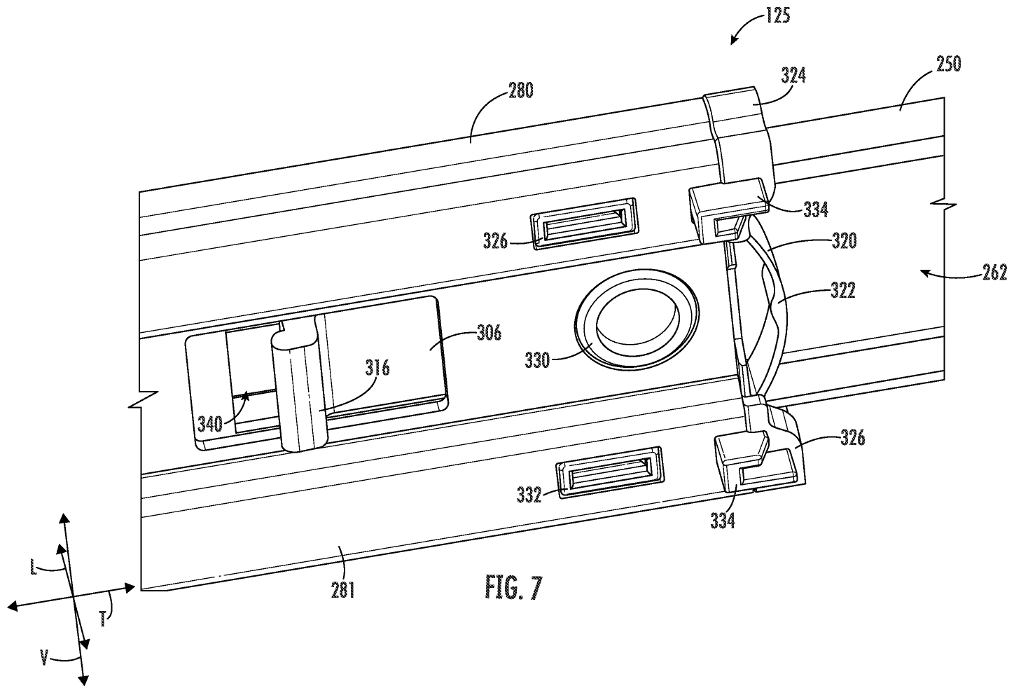

Referring now to FIGS. 3 through 7, a slide assembly and components thereof are provided. Specifically, FIG. 3 depicts a perspective view of the slide assembly 125 according to one or more exemplary aspects of the present subject matter. FIG. 4 depicts a perspective view of the inner member 250 of the slide assembly 125 according to one or more exemplary aspects of the present subject matter. FIGS. 5 and 6 each depict perspective view of an end cap 300 of the slide assembly 125 according to one or more exemplary aspects of the present subject matter. FIG. 7 depicts a close-up perspective view of the slide assembly 125 according to one or more exemplary aspects of the present subject matter.

For the purposes of clarity, only a discrete slide assembly 125 and components thereof are generally described herein. Nonetheless, it is understood that an identical slide assembly 125 may be mounted on the laterally opposing tub side wall 128 and may mirror the discrete slide assembly 125 described herein.

The slide assembly 125 may generally include an inner member 250 that may be directly mounted on, such as attached to, e.g., by mechanical fasteners, the tub side wall 128 and a ball bearing slide 280 that may be slidably mounted onto the inner member 250. In some embodiments, the inner member 250 may generally include a slide rail body 256 that may transversely extend, e.g., approximately along or approximately parallel to the transverse direction T, from a front end 252 to a back end 254. Furthermore, the slide rail body 256 may include a first surface 262 and a second surface (not depicted) that may be spaced apart from one another approximately along the lateral direction L. When the inner member 250 may be mounted to the tub side wall 128, the first surface 262 of the slide rail body 256 may face generally toward the interior of the tub 104 and the second surface (not depicted) of the slide rail body 256 may face generally toward the tub side wall 128.

In some embodiments, the slide rail body 256 may include a top rail 251 and a bottom rail 253. The top rail 251 and the bottom rail 253 may each define a rail width approximately along the lateral direction L and a rail height approximately along the vertical direction V. In some embodiments, for instance FIG. 4, the top rail 251 and the bottom rail 253 may each taper, e.g., decrease in rail width and in rail height, towards the front end 252 of the slide rail body 265. For example, such taper may allow other elements, for instance, the ball bearing slide 280, to slide onto and over the top rail 251 and the bottom rail 253 of the slide rail body 256 without significant impediment. As used herein, tapered is intended to include not only flat surfaces, but rounded surfaces as well, so long as the angle of the taper is small enough to permit the elements, e.g., the ball bearing slide 280, to slide from the front end 252 of the inner member 250 to approximately the back end 254 of the inner member 250 without significant impediment, e.g., without sliding being prevented.

Moreover, in some embodiments, the slide rail body 256 may include a back tab 260 that may be shaped to prevent elements, e.g., the ball bearing slide 280, from back sliding, e.g., from sliding past the back end 254 of the inner member 250. For example, in some embodiments, e.g., as illustrated in FIG. 4, the back tab 260 may form a ninety degree angle that may prevent back sliding of the ball bearing slide 280, although this precise geometry is not necessary to fall within the scope of the present disclosure. It will be readily apparent to those skilled in the art that the back tab 260 may be at any angle which may prevent back sliding would suffice.

In some embodiments, the slide rail body 256 may include one or more recessed portions, for example, the slide rail body 256 may include a first recessed portion 264, a second recessed portion 266, and a third recessed portion 268 that may be recessed in the lateral direction L, e.g., toward the tub side wall 128 such as when the inner member 250 is mounted to the tub side wall 128. The one or more recessed portions may each have approximately the same lateral depth, e.g., the lateral depth of the first recessed portion 264 may be substantially the same as the lateral depth of the second recessed portion 266. In some embodiments, the inner member 250 may be mounted to the tub side wall 128 at the recessed portion(s) 264, 266, 268. For example, the inner member 250 may be mechanically fastened to the tub side wall 128 at the recessed portions by any suitable fastener or process, for instance e.g., bolts, screw, rivets, TOX®, etc. As will be understood by those skilled in the art, the number of recessed portions depicted are provided by way of example only. In additional embodiments, any suitable number of recessed portions may be provided. For example, in additional embodiments, only two recessed portions may be provided, or more than three recessed portions may be provided, such as four or more recessed portions may be provided.

Additionally, in some embodiments, the inner member 250 may include an engagement tab 270 that may be connected to the slide rail body 256 on one end and may be free on its other end. The engagement tab 270 may be positioned proximate to the front end 252 of the inner member 250. For instance, the engagement tab 270 may be positioned closer to the front end of the inner member 250 than the back end 254 of the inner member 250, such as within the first fifty percent of the transverse length of the inner member 250.

In some embodiments, the ball bearing slide 280 may extend approximately along or approximately parallel to the transverse direction T from a front end 282 to a back end 284. The ball bearing slide 280 may also extend approximately along or approximately parallel to the lateral direction L from a front side 281 to a second side (not depicted). When the ball bearing slide 280 may be slidably mounted onto the inner member 250, the front side 281 of the ball bearing slide 280 may face generally toward the interior of the tub 104 and the second side of the ball bearing slide 280 may face generally towards the tub side wall 128.

Moreover, in some embodiments, the slide assembly 125 may additionally include an end cap 300 that may be attached to and positioned, at least partially, within the ball bearing slide 280, whereby engagement between the ball bearing slide 280 and the inner member 250 may be facilitated by the end cap 300 during assembly of the slide assembly 125, and whereby disengagement of the ball bearing slide 280 from the inner member 250 may be facilitated by the end cap 300 during disassembly of the slide assembly 125.

Specifically, the end cap 300 may be attached to the back end 284 of the ball bearing slide 280, wherein the end cap 300 may be an end cap for the back end 284 of the ball bearing slide 280, and wherein the end cap 300 may be an engagement mechanism that may facilitate the engagement of the ball bearing slide 280 to the inner member 250 and may facilitate the disengagement of the ball bearing slide 280 from the inner member 250.

As depicted in FIGS. 5 and 6, the end cap 300 may extend approximately along or approximately parallel to the transverse direction T from a front end 302 to a back end 304. The end cap 300 may also extend approximately along or approximately parallel to the lateral direction L, from a first side 303 to a second side 305. In some embodiments, such as when the slide assembly 125 may be mounted to the tub side wall 128, e.g., FIG. 3, the first side 303 may face generally toward the interior of the tub 104 and the second side 305 may face generally toward the tub side wall 128.

Further, the end cap 300 may generally include a lever body 306 and an end cap body 320 that are integrally formed. The end cap body 320 may include a handle 322, a pair of slide caps 324 positioned at opposing vertical ends of the end cap body 320, and a pair of guide rails 326 that may each extend approximately along or approximately parallel to the transverse direction T from a respective slide cap 324 toward the front end 302 of the end cap 300. In addition, as may be seen in FIG. 6, the end cap body 320 may include a locking ring 330, a pair of locking blocks 332, and a pair of locking hooks 334 that each may be positioned at, or on, the first side 303 of the end cap 300.

In some embodiments, the end cap 300 may be positioned, at least partially, within the ball bearing slide 280 and may be attached to the ball bearing slide 280 via the numerous locking features of the end cap 300, e.g., by the locking ring 330, the locking blocks 332, and the locking hooks 334, interacting with and interfacing with the ball bearing slide 280, e.g., as may be seen in FIG. 7. For instance, the end cap body 320 may be attached directly to the back end 284 of the ball bearing slide 280, and the lever body 306 may be positioned freely within the back end 284 of the ball bearing slide 280. Specifically, joining operations, such as but not limited to, interference fits, and snap fits may be used to attach the end cap 300 to the ball bearing slide 280.

For example, the locking ring 330 and the pair of locking blocks 332 may each be attached to the ball bearing slide 280 via a snap fit, wherein the locking ring 330 and the pair of locking blocks 332 may each be snapped into a corresponding slot defined through the ball bearing slide 280 during a joining operation. As used herein “snapped” may refer to a component, e.g., the locking ring 330 and the pair of locking blocks 332, engaging with, and mating to, a mating component, e.g., the corresponding slots defined through the ball bearing slide 280, during a joining operation e.g., during assembly, maintenance, etc., of the slide assembly 125. Furthermore, the component may engage with, and be mated to, the mating component by deflecting briefly during the joining operation and catching in a depression of the mating component, e.g., depressions in the corresponding slots defined through the ball bearing slide 280 (FIG. 7).

As another example, the pair of locking hooks 334 may slide over the front side 281 of the ball bearing slide 280 and may tightly interface with the front side 281 of the ball bearing slide 280, as shown, e.g., in FIG. 7, wherein the end cap body 320 is attached to the ball bearing slide 280 via an interference fit between the ball bearing slide 280 and each locking hook 334. For example, the locking hooks 334 and the ball bearing slide 280 may be interfaced such that the pair of locking hooks 334 may be held in place by friction, to form the interference fit between the locking hooks 334 and the ball bearing slide 280.

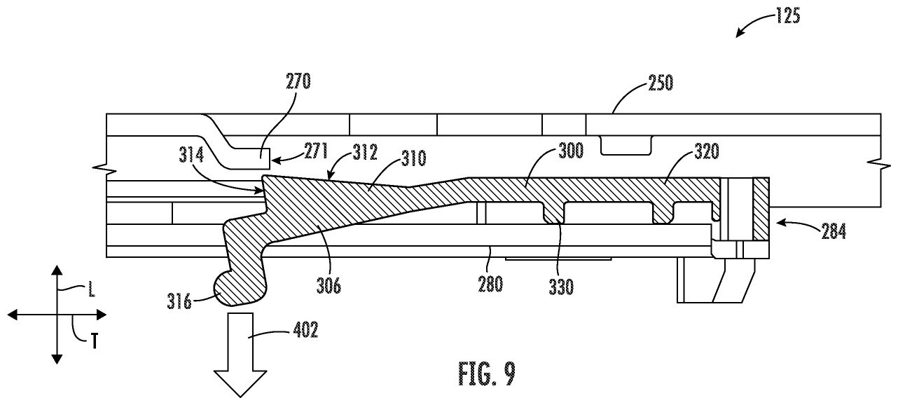

The lever body 306 may be positioned freely within the ball bearing slide 280, e.g., the lever body 306 may be positioned within the ball bearing slide 280 and may not be directly attached to the ball bearing slide 280. Further, the lever body 306 may be translatable approximately along the lateral direction L between an unflexed position, e.g., FIGS. 5 and 6, wherein the lever body 306 is approximately in line with or approximately parallel to the end cap body 320 and a flexed position, e.g., FIG. 9, wherein the lever body 306 is flexed, e.g., translated approximately along or approximately parallel to the lateral direction L, relative to the end cap body 320. Furthermore, in the flexed positioned, the lever body 306 may be translated inward, e.g., toward the interior of the tub 104 approximately along or parallel to the lateral direction L such as when the slide assembly 125 is mounted to the tub side wall 128. The lever body 306 may be biased to the unflexed position.

The lever body 306 may include a handle 316 and a ramp 310. In some embodiments, the ramp 310 may be offset approximately along or parallel to the transverse direction T from the handle 316 and may include a ramp surface 312 and a mating surface 314 at the front end of the ramp 310. Furthermore, in some embodiments, e.g., FIG. 7, the handle 316 may be accessible through a lever slot 340 defined through the front side 281 of the ball bearing slide 280. The handle 316 may be any suitable style of handle that may be used to control, e.g., by a user of the dishwasher appliance 100, the translation of the lever body 306, for instance, the handle 316 may be any suitable handle that a user of the dishwasher appliance 100 may grab, such as by pinching, to translate the lever body 306 relative to the end cap body 320. In addition, the lever slot 340 may be sized such that a user of the dishwasher appliance 100 may be capable of grabbing, such as by pinching, the handle 316 and may also pull the handle 316 inward, such as approximately along or approximately parallel to the lateral direction L.

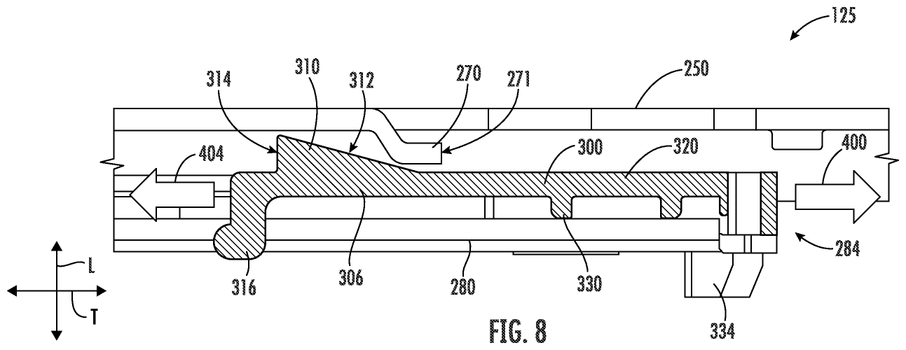

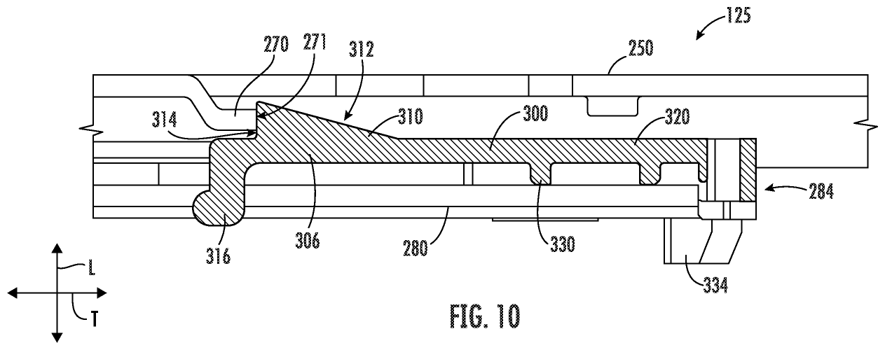

Referring now to FIGS. 8 through 10, partial cross-sectional views of the slide assembly 125 are provided. Particularly, FIG. 8 depicts the ball bearing slide 280 in a disengaged position, FIG. 9 depicts the ball bearing slide 280 in a transitionary position and FIG. 10 depicts the ball bearing slide 280 in an engaged position.

In some embodiments, e.g., FIG. 8, the ball bearing slide 280 may be in a disengaged position, wherein the ball bearing slide 280 is not fully attached to the inner member 250 and the ball bearing slide 280 may still be removable from the inner member 250. To transition the ball bearing slide 280 from the disengaged position to an engaged position, e.g., a position wherein the ball bearing slide is slidably mounted to the inner member 250, wherein the ball bearing slide 280 is inhibited from sliding off the inner member 250 by the engagement tab 270, and wherein the mating surface 314 of the ramp 310 may be a back stop for the ball bearing slide 280, e.g., may inhibit the ball bearing slide 280 from extending beyond the extended loading position, the back end 284 of the ball bearing slide 280 may be slid onto the front end 252 of the inner member 250. For instance, the ball bearing slide 280 may be in a disengaged position, e.g., a position of the ball bearing slide 280 wherein the ball bearing slide 280 is not fully attached to the inner member 250 and the ball bearing slide 280 may still be removable from the inner member 250, as the ball bearing slide 280 is initially slide onto the inner member 250. For example, to transition the ball bearing slide 280 from the disengaged position to the engaged position, a user of the dishwasher appliance 100 may slide the ball bearing slide 280 onto the inner member 250 in the direction of arrow 400 which may be approximately in the transverse direction T substantially toward the back wall 111 of the tub 104.

Moreover, as the ball bearing slide 280 is slid onto the inner member 250, e.g., to transition the ball bearing slide 280 from the disengaged position to the engaged position, the engagement tab 270 of the inner member 250 may begin to contact the ramp surface 312 of the lever body 306. As the engagement tab 270 passes over the ramp 310, and more particularly the ramp surface 312, the engagement tab 270 may urge the lever body 306 of the end cap 300 to or toward the flexed position, e.g., as the engagement tab 270 may be relatively rigid when compared to the lever body 306. For instance, as the engagement tab 270 passes over the ramp surface 312, the lever body 306 may flex outward approximately along or approximately parallel to the lateral direction L relative to the end cap body 320, such as approximately in the direction of arrow 402, e.g., FIG. 9. In some instances, this urging of the lever body 306 to or toward the flexed position may be referred to as a transitionary position, e.g., a position wherein the lever body 306 may be urged to or toward the flexed position such that the ball bearing slide 280 may be permitted to transition between the engaged position and the disengaged position.

Furthermore, as the ball bearing slide 280 is slid further along the inner member 250 in the direction of arrow of 400, the engagement tab 270 may pass the front end of the ramp 310 wherein the lever body 306 may transition back to the unflexed position, e.g., as the lever body 306 may be biased toward the unflexed position. The ball bearing slide 280 and the inner member 250 may then be engaged as the lever body 306, and more particularly, the mating surface 314 of the lever body 306 may now act as a back stop for the ball bearing slide 280. For instance, the mating surface 314 of the lever body 306 may inhibit forward movement, e.g., movement of the ball bearing slide 280 in a direction opposite of the direction of arrow 400, such as in the direction of arrow 404 described below, of the ball bearing slide 280 past the extended loading position such that a mating surface 271 of the engagement tab 270 may be inhibited from moving past the mating surface 314 of the lever body 306.

To transition the ball bearing slide 280 back to the disengaged position, such as during disassembly or maintenance of the slide assembly 125, the process described above may be performed generally in reverse. For instance, to transition the ball bearing slide 280 from the engaged position to the disengaged position, the lever body 306 of the end cap 300 may be pulled into the flexed position, e.g., as depicted in FIG. 9, wherein the lever body 306 of the end cap 300 may be cleared approximately along the lateral direction L from the engagement tab 270, and wherein the ball bearing slide 280 may be permitted to be removed from the engaged position. For instance, the handle 316 of the lever body 306 may be pulled approximately along the lateral direction L, such as in the direction of arrow 402. For instance, a user may pinch the handle 316, and pull the handle 316 inward when the slide assembly 125 is attached to a tub side wall 128.

Furthermore, during disassembly of the slide assembly 125, disengagement of the ball bearing slide 280 from the inner member 250 may be permitted by the lever body 306 being translated to the flexed position. For instance, when the lever body 306 is in the flexed position, e.g., when the handle 316 of the lever body 306 is being pulled approximately in the direction of arrow 402, the ball bearing slide 280 may be permitted to slide off the inner member 250 as the lever body 306 may be cleared from the engagement tab 270, e.g., the mating surface 314 of the lever body 306 and the mating surface 271 of the engagement tab 270 may not interface, such as when the ball bearing slide 280 may slide on the inner member 250. The ball bearing slide 280 may then be slid off of the inner member 250, e.g., by sliding the ball bearing slide 280 in the direction of arrow 404, e.g., FIG. 8, wherein arrow 404 may be approximately along or approximately along the transverse direction T, such as during disassembly, maintenance, or any suitable condition of the dishwasher appliance 100.

Embodiments of the dishwasher appliance 100 provided herein may advantageously improve assembly and disassembly of the slide assembly. For instance, but without limitation, by integrating the engagement mechanism of the slide assembly with an end cap of the ball bearing slide, the part count of the slide assembly may be reduced, as the conventional lever part, e.g., a part of the ball bearing slide that is generally a separate part from the end cap, may be eliminated. In addition, the integration of the engagement mechanism and the end cap may increase space within the slide assembly for various other applications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance defining a vertical direction, a lateral direction, and a transverse direction, the dishwasher appliance comprising:
a tub defining a wash chamber, the tub comprising a tub side wall; and
a slide assembly mounted within the dishwasher appliance, the slide assembly comprising:
an inner member attached to the tub side wall, the inner member comprising an engagement tab;
a ball bearing slide transitionable between an engaged position and a disengaged position relative to the inner member; and
an end cap attached to the ball bearing slide, the end cap comprising an end cap body and a lever body, wherein the lever body is positioned freely within the ball bearing slide.

2. The dishwasher appliance of claim 1, wherein the inner member extends approximately along the transverse direction from a front end to a back end and wherein the engagement tab is positioned proximate the front end of the inner member.

3. The dishwasher appliance of claim 1, wherein the ball bearing slide extends approximately along a first direction from a front end to a back end and wherein the end cap body is attached directly to the back end of the ball bearing slide.

4. The dishwasher appliance of claim 1, wherein the end cap body and the lever body are integrally formed.

5. The dishwasher appliance of claim 1, wherein the lever body comprises a handle, wherein the ball bearing slide comprises a front side and a lever slot defined through the front side, and wherein the handle is extended through the lever slot.

6. The dishwasher appliance of claim 1, wherein the end cap body comprises a locking ring and a pair of locking blocks, wherein the locking ring and the pair of locking blocks are each attached to the ball bearing slide via a snap fit.

7. The dishwasher appliance of claim 1, wherein the end cap body comprises a pair of locking hooks and wherein the end cap body is attached to the ball bearing slide via an interference fit between the ball bearing slide and each locking hook.

8. The dishwasher appliance of claim 1, wherein the lever body comprises a ramp having a mating surface, wherein in the engaged position of the ball bearing slide the mating surface of the ramp is a back stop for the ball bearing slide.

9. The dishwasher appliance of claim 1, wherein the lever body is translatable approximately along the lateral direction between an unflexed position and a flexed position relative to the end cap body.

10. The dishwasher appliance of claim 9, wherein the lever body inhibits movement of the ball bearing slide from the engaged position to the disengaged position when the lever body is in the unflexed position and wherein the ball bearing slide is permitted to transition between the engaged position and the disengaged position when the lever body is in the flexed position.

11. A slide assembly for a dishwasher appliance, the slide assembly configured to be mounted within the dishwasher appliance, the slide assembly comprising:
an inner member comprising an engagement tab;
a ball bearing slide transitionable between an engaged position and a disengaged position relative to the inner member; and
an end cap attached to and positioned, at least partially, within the ball bearing slide.

12. The slide assembly of claim 11, wherein the inner member extends approximately along a first direction from a front end to a back end and wherein the engagement tab is position proximate the front end of the inner member.

13. The slide assembly of claim 11, wherein the ball bearing slide extends approximately along a first direction from a front end to a back end, wherein the end cap comprises an end cap body and a lever body, wherein the end cap body is attached directly to the back end of the ball bearing slide, and wherein the lever body is positioned freely within the ball bearing slide the back end of the ball bearing slide.

14. The slide assembly of claim 13, wherein the end cap body and the lever body are integrally formed.

15. The slide assembly of claim 13, wherein the lever body comprises a handle, wherein the ball bearing slide comprises front side and a lever slot defined through the front side, wherein the handle is extended through the lever slot.

16. The slide assembly of claim 13, wherein the end cap body comprises a locking ring and a pair of locking blocks, wherein the locking ring and the pair of locking blocks are each attached to the ball bearing slide via a snap fit.

17. The slide assembly of claim 13, wherein the end cap body comprises a pair of locking hooks and wherein the end cap body is attached to the ball bearing slide via an interference fit between the ball bearing slide and each locking hook.

18. The slide assembly of claim 13, wherein the lever body comprises a ramp having a mating surface, wherein in the engaged position of the ball bearing slide the mating surface of the ramp is a back stop for the ball bearing slide.

19. The slide assembly of claim 13, wherein the lever body is translatable approximately along a first direction between an unflexed position and a flexed position relative to the end cap body.

20. The slide assembly of claim 19, wherein the ball bearing slide is permitted to transition between the engaged position and the disengaged position when the lever body is in the flexed position.
